(19) United States
(12) Patent Application Publication
(10) Pub. No.: US 2016/0289507 A1
(43) Pub. Date: Oct. 6, 2016

(54) RUBBERIZED GRIP TAPE

(71) Applicants: Dave Markisich, Woods Cross, UT (US); Andrew Markisich, Woods Cross, UT (US)

(72) Inventors: Dave Markisich, Woods Cross, UT (US); Andrew Markisich, Woods Cross, UT (US)

(21) Appl. No.: 14/677,600

(22) Filed: Apr. 2, 2015

(51) Int. Cl. C09J 7/04; A63B 29/08; B29C 35/08; B29C 70/02; B29C 47/00; B29C 47/06

(52) U.S. Cl. CPC C09J 7/04; B29C 47/0026; B29C 47/06; B29C 35/0805; B29C 70/021; A63B 29/08; B29C 2035/0827; B29L 2007/007

(57) ABSTRACT

The present invention relates generally to a rubberized grip tape and more specifically, to a rubberized grip tape used for rock climbing. The rubberized tape providing, hand protection and increased friction and grip.

### BACKGROUND OF THE INVENTION

The present invention relates generally to a rubberized grip tape and more specifically, to a rubberized grip tape having a tacky vulcanized rubber surface used primarily for rock climbing.

Rock climbing in essence is pure sport, pitting man against nature, while using minimal amounts of equipment. The sports of rock climbing and bouldering, technical climbing with low vertical exposure, has exploded in the past decade, this is largely due to the advent of adventure sports and the development of indoor climbing gyms. In most cases a person can become involved in climbing by simply arriving at a local climbing gym, renting a pair shoes and getting on the artificial wall. Both natural walls with established routes, and gym climbing walls, have climbs that are rated for difficulty. A climber can chose a route suited for their personal skill level or chose a route that challenges their capability and requires multiple attempts to master. Basic equipment choices will allow climbers to ascend or conquer more difficult routes. Early in the sport of rock climbing, climbers used rigid soled mountaineering boots; these boots are effective if the climber can find a substantial surface to stand on or a significant crack that can be purchased with the toe of the boots. However, the stiffness of the boot did not allow for articulation of the foot for “smearing” against the rock, for inserting into small cracks or standing on small protrusions. The rating of difficultly of climbable routes skyrocketed once modern climbing shoes, with a flexible vulcanized rubber sole, were introduced.

Climbing is mentally challenging, physically taxing and will cause “wear and tear” on the climber's body. Most significantly, the climber expects cuts and abrasions on the hands and fingers; especially when “crack climbing” or jamming and wedging the fingers into a vertical break in the rock as a climbing hold. For years climbers have resorted to using cloth medical tape, such as the tape disclosed in U.S. Pat. No. 2,187,563 issued to Raymond E. Thomas, Jan. 16, 1940 (hereinafter, Thomas). The tape in Thomas is a loosely woven cotton fabric that is treated with a paraffin wax based emulsion for water repellency and has a natural rubber based adhesive back. The modern equivalent is woven cotton or synthetic fabric treated with a latex emulsion and has an adhesive back. Climbers will wrap each finger individually, protecting the finger tips and knuckles as necessary. A climber may also wrap finger joints to protect against sprains and ligament damage. The tape is inexpensive protection for the climber's hands and fingers, but it has limitations, including, unwrapping, wear, and reducing the climber's natural friction and grip.

Climbers may also choose to use climbing chalk in order to dry sweating hands and to improve friction between their finger tips and the climbing hold or natural rock. Climbing gyms will on occasion remove the artificial holds and wash using soapy water to remove skin oil and climbing chalk residue to restore the hold texture. When climbing outdoors on well-established routes it is typically obvious where each reasonable hand hold or purchase is on the wall because of the chalk residue built up on the rock. For climbers this “connect the dots” method can become a crutch that eliminates some of the learning or creativity required to identify the best holds. For non-climbers and naturalists, the chalk marks on a natural rock face may be considered an eyesore, or in extreme situations, this may be considered defacing a natural treasure.

What is needed is an inexpensive climbing tape that stays wrapped, does not wear through, aides a climber's natural finger friction and grip and may help eliminate or reduce the use of climbing chalk.

An improved rock climbing tape may change rock climbing and a climber's ability, similar to the progress experienced following the introduction of specialized rock climbing shoes.

### SUMMARY OF THE INVENTION

A first embodiment of the present invention is a rubberized grip tape used for protection of the climber's hands and fingers. The tape can be wrapped individually around the finger tips and may be applied over the knuckles. The tape has a thin cross-section, allowing for multiple layers, or wraps of tape, without unduly inhibiting the climber's tactile sensation. The rubberized grip tape uses the same compound as, or similar to, the vulcanized rubber used on climbing shoes on the top surface, with a releasable adhesive on the bottom surface. The rubberized grip tape providing enhanced friction and gripping strength to the climber and resists wear due to abrasion. The releasable adhesive backing provides a secure attachment of the tape to the user's skin and will resist unwrapping even when exposed to moisture or sweat.

The climbing tape can be created by spreading or spraying a thin layer of vulcanized rubber emulsion onto fabric based adhesive tape. The first embodiment of the present invention may also be suitable for other climbing and non-climbing applications, including, but not limited to, taping worn climbing shoes, providing a grip on an ice axe, providing a grip on an ascender, protecting the fabric and frame of a climbing ledge or platform, providing insulation on a backpacking stove, and providing grip or camouflage on a firearm.

In another embodiment of the present invention, the rubberized grip tape can be created by spreading or spraying a vulcanized rubber emulsion over a cotton or synthetic mesh support frame. After the emulsion has sufficiently cured, an adhesive is applied to the bottom surface. It is contemplated that the adhesive is one of, spread or sprayed on, or the adhesive is applied as a tape or film having adhesive on both surfaces.

In yet another embodiment of the present invention, the rubberized grip tape can be created by blending reinforcement fibers into the vulcanized rubber emulsion and extruding or spreading the emulsion onto a release agent for curing. The reinforcement fibers may be a natural fiber such as, but not limited to, jute, hemp, coconut husk, or cotton. The reinforcement fiber may also be a synthetic such as nylon or Kevlar.

In one embodiment of the present invention, the rubber emulsion for the rubberized grip tape can be formed using a substantial amount of recycled materials. It is contemplated that the base rubber compound or granules can be ground rubber sourced from recycled rock climbing shoe soles, bicycle tires or automobile tires. A ground up bias ply tire may be used as a source for both rubber granules and for support matrix fibers reclaimed from the nylon or aramid belts. An emulsion can be created by blending the recycled rubber material and fibers along with a binding agent and solvent.

One embodiment of the present invention the vulcanized rubber emulsion may include added natural material to increase the overall coefficient of friction. The nature material may be a rock product such as silica sand or pumice or an organic material such as crushed walnut hulls.

One embodiment of the present invention, or rubberized grip tape may include designs or patterns in the rubberized surface. The patterns may include, but are not limited to, zigzag, waves, ripples or ribs. The pattern may also include basic shapes, such as, stars, diamonds, hearts or triangles. The pattern may include themed images such as a rock climbing, climbing equipment, or images from nature or art. The patterns may include logos, such as the logo for the manufacturer or for a climbing event sponsor.

In one embodiment of the present invention, the rubberized grip tape is multicolor or the color is customizable. In another embodiment of the present invention, the surface of the rubberized grip tape can be cut, grooved or siped.

In another embodiment of the present invention, the rubberized grip tape can be formed as a continuous strip on a roll.

In another embodiment, the rubberized grip tape can be formed as pre-cut strips applied to a roll. In yet another embodiment, the rubberized grip tape can be formed as pre-cut strips applied to a releasable backer sheet.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set forth hereinafter.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIGS. 1A and 1B illustrate one embodiment of the present invention or rubberized grip tape;

FIG. 2A illustrates one embodiment of the present invention or rubberized grip tape formed on a support mesh;

FIG. 2B illustrates one embodiment of the present invention or rubberized grip tape formed using reinforcement fibers;

FIGS. 3A, 3B and 3C illustrate one embodiment of the present invention or rubberized grip tape having a design surface;

FIG. 4 illustrates one embodiment of the present invention or rubberized grip tape formed as a sheet;

FIG. 5 illustrates one method of manufacture for the present invention or rubberized grip tape, and;

FIG. 6 illustrates one method of manufacture for the present invention or rubberized grip tape.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with definitions set out below. As used herein, the terms “comprising,” “including,” “containing,” “characterized by,” and the grammatical equivalents thereof are inclusive or open-ended terms that do not exclude additional, unrecited elements or method processes.

The disclosure relates to rubberized grip tape or more specifically to, rubberized grip tape used for rock climbing.

Rubberized meaning to coat or cover with rubber, natural rubber, vulcanized rubber or an equivalent material as currently understood in the art or material yet to be developed. The rubberized coat having a high friction coefficient and comprised of a compound comparable to the sole of a rock climbing shoe.

Emulsion meaning a liquid, semi-solid or a blend of liquids with one or more solids.

Curing meaning the semi-solid emulsion sets up to a rubberized solid section.

Tape meaning an elongate flexible strip having a first base material with a releasable adhesive on the bottom surface of the base material.

Siped meaning the rubber surface is modified with thin cuts or grooves.

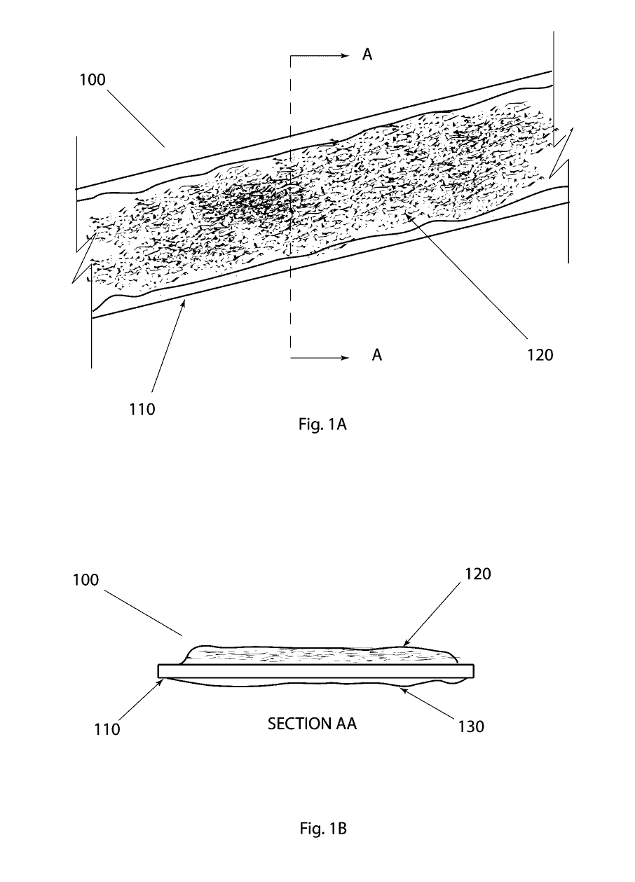

Illustrated in FIGS. 1A and 1B, is one embodiment of the present invention, rubberized grip tape 100, having a rubberized emulsion grip surface 120 applied to a reinforced cloth backing 110 and including a releasable adhesive 130. The backing material 110 can be a woven cotton or synthetic cloth or may be cotton or synthetic cloth that is treated with latex or similar emulsion. Releasable adhesive 130 is resistant to moisture, body oils, and sweat.

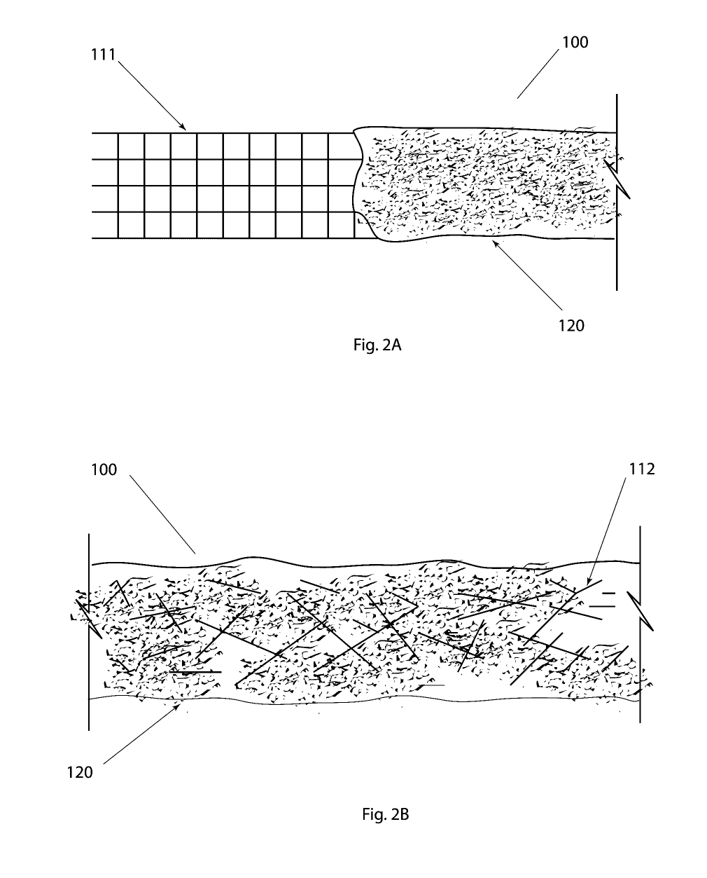

FIG. 2A is another embodiment of the present invention, or rubberized grip tape 100 formed by spreading or spraying a vulcanized rubber emulsion 120 over a support mesh 111. The support mesh 111 can be formed using a natural or synthetic fiber mat.

FIG. 2B is another embodiment of the present invention, or rubberized grip tape 100 formed by spreading or extruding vulcanized rubber emulsion 120 which is structurally supported by reinforcement fibers 112. Reinforcement fibers 112 may be natural fibers, such as but not limited to, cotton, jute, hemp, or coconut husk. Synthetic options include, but are not limited to, nylon and Kevlar.

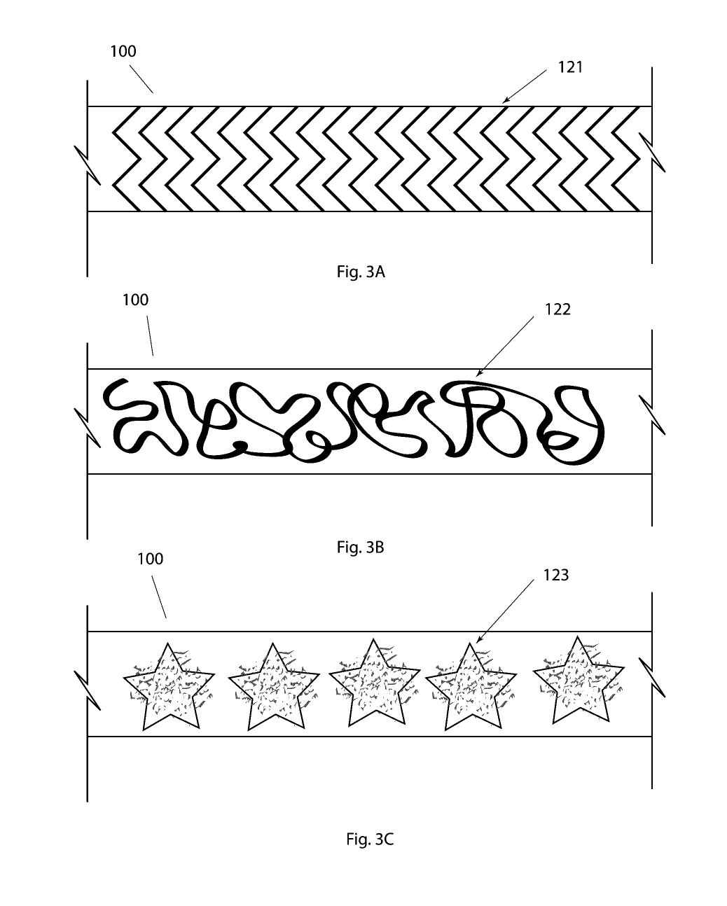

FIGS. 3A, 3B and 3C are another embodiment of the present invention, or rubberized grip tape 100 where the grip material is distributed in a pattern or design, such as zigzag 121, scroll 122 or images such as the stars 123 shown in FIG. 3C. It is contemplated that emulsion 120 is multicolor or the color is customizable. Images may be formed on tape 100 using a template cutout, form or may be stamped.

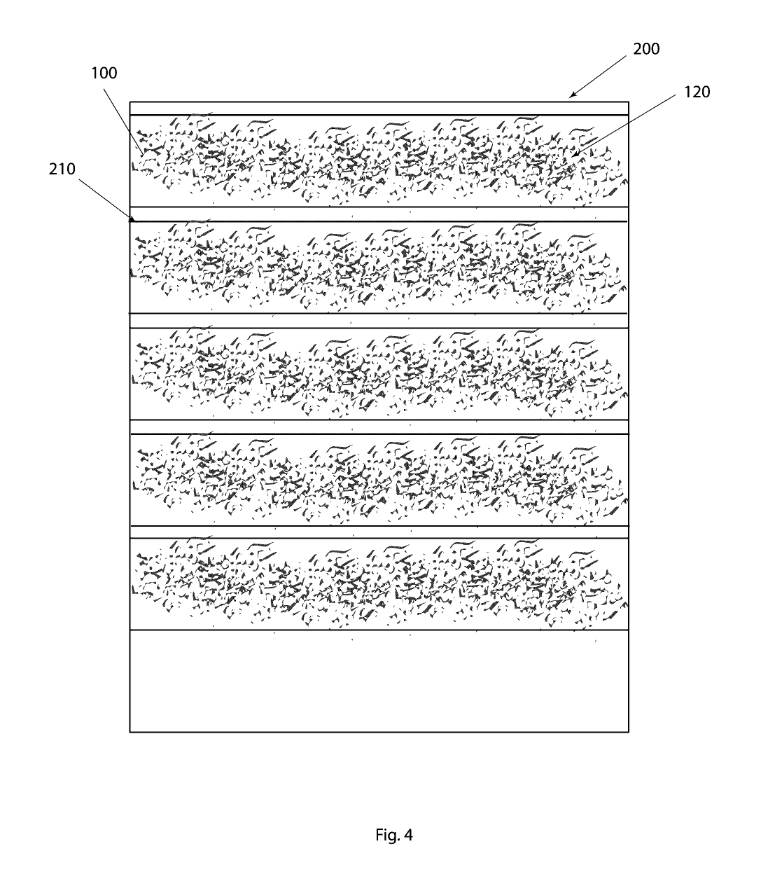

FIG. 4 is yet another embodiment of the present invention, or rubberized grip tape 100 formed on a releasable backer sheet 200. The rubberized emulsion 120 can be applied to individual adhesive strips separated by a cutline or margin 120. This embodiment presents the advantage of precut strips and the ability to treat or spread vulcanized rubber emulsion 120 over the entire backer sheet 200 prior to curing.

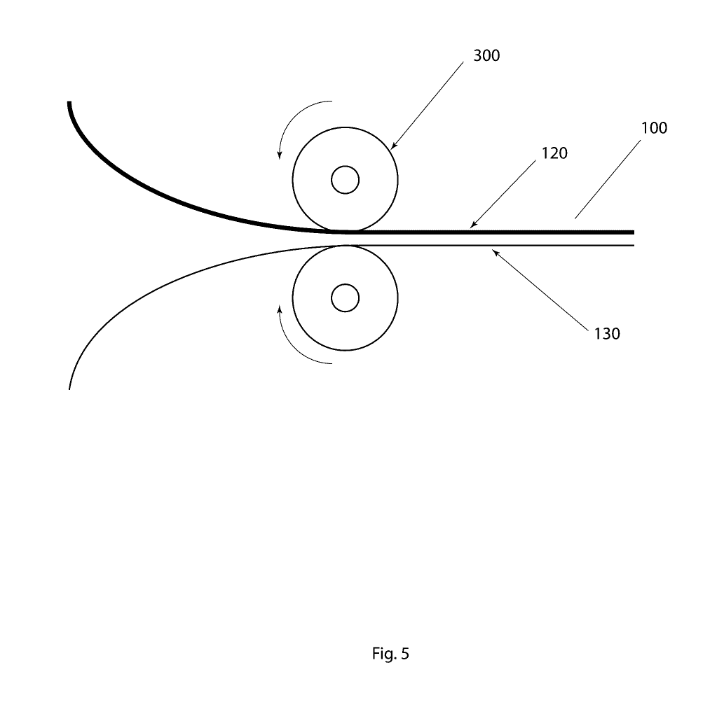

FIG. 5 is one embodiment of the present invention, or rubberized grip tape 100, where a preformed emulsion strip 120 is mechanically attached to an adhesive film 130 by equipment such a press or rollers 300 as shown.

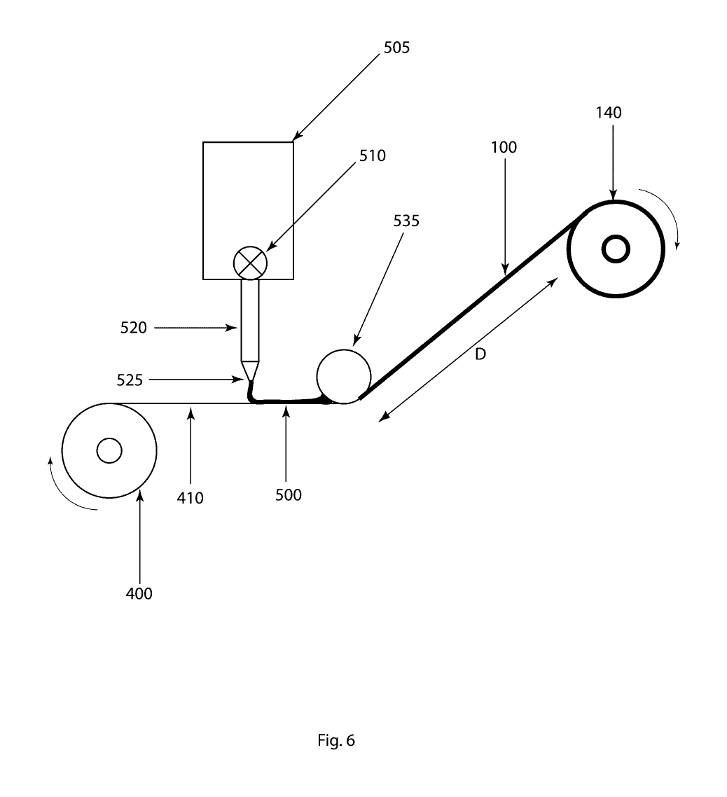

FIG. 6 is one embodiment of the present invention, or rubberized grip tape 100 formed by removing preformed cloth tape 410 directly from a roll 400 or bulk spool (not shown) and applying rubber emulsion 500 directly to the cloth tape 410 using calibrated distribution. The rubber emulsion is spread evenly across the face of tape 410 using a spreader rod or roller 535. Tape 410 will then travel a distance D which is set to allow sufficient time for emulsion 500 to dry prior to being spooled on a commercial sales roll 140. The emulsion distribution system will include a bulk reservoir 505 a variable pressurization pump 510, and a nozzle 520 having a specific orifice 525. It is contemplated that the variable pressurization pump 510 may be a plunger assembly having a rack and pinion arrangement, or a plunger having a screw drive or the pressurization pump 510 may be a positive displacement pump such as a gear rotor pump. Proper distribution of the rubberized emulsion 500 is achieved where the emulsion 500 is spread in a uniform layer from edge to edge across the face of the cloth tape 410. Controlling the spread of emulsion 500 can be achieved by adjusting the variable pressurization pump 510 output, changing the orifice 525 diameter or changing the rate of speed in which tape 410 is moved through the process. Additionally, the amount of the tension applied to tape 410, plus the angle in which the tape 410 is pulled against spreader rod 535 can affect the quality of the final product. It is contemplated that emulsion 500 may include a curing agent which is reactive to ultra-violet light and an appropriate light source may be included in the system within the distance D. The use of a ultra-violet curing agent is expected to significantly reduce drying and overall process time.

1. A grip tape comprising;
a rubberized exterior surface formed from a rubber emulsion,
a support matrix, and,
an interior surface having an adhesive.

2. The grip tape of claim 1 wherein the rubberized exterior surface includes one of natural rubber, vulcanized rubber and recycled rubber.

3. The grip tape of claim 2 wherein the recycled rubber is ground into granules from one or more of rock climbing shoe soles, bicycle tires and automobile tires.

4. The grip tape of claim 1 wherein the rubberized exterior surface includes friction material such as one of silica, pumice, and ground walnut hulls.

5. The grip tape of claim 1 wherein the support matrix is a cotton tape.

6. The grip tape of claim 1 wherein the support matrix is mesh material.

7. The grip tape of claim 1 wherein the support matrix is fiber material blended with the rubber emulsion.

8. The grip tape of claim 7 wherein the fiber material is one of cotton fiber, hemp, jute, coconut husk, nylon and Kevlar.

9. The grip tape of claim 1 wherein the rubberized exterior surface includes a pattern.

10. The grip tape of claim 1 wherein the rubberized exterior surface includes custom images.

11. The grip tape of claim 1 wherein the rubberized exterior surface is siped.

12. The grip tape of claim 1 wherein the rubberized exterior surface includes one or more colors.

13. A method of making grip tape comprising;
providing a support matrix,
the support matrix having an exterior surface and an interior surface,
providing a rubber emulsion,
applying the rubber emulsion to the exterior surface of the support matrix using a metered pump,
moving the exterior surface across a spreader rod to distribute the rubber emulsion evenly across the exterior surface,
curing the rubber emulsion, and,
applying a releasable adhesive to the interior surface of the support matrix.

14. The method of claim 13 wherein the rubber emulsion includes an ultraviolet curing agent.

15. The method of claim 14 including providing an ultraviolet curing light source.

16. The method of claim 13 wherein the rubber emulsion includes recycled material.

17. The method of claim 16 wherein the recycled material is one of ground climbing shoe soles, bicycle tires and automotive tires.

18. The method of claim 13 wherein the rubber emulsion includes friction material.

19. A method of making grip tape comprising;
blending a rubber emulsion with support fibers,
extruding the rubber emulsion to form a thin tape,
the thin tape extruded onto a release surface,
curing the rubber emulsion, and,
applying a releasable adhesive to the interior surface of the thin tape.

20. The method of claim 19 wherein curing is accomplished using ultraviolet light.
